(19) United States
(12) Patent Application Publication
(10) Pub. No.: US 2008/0143148 A1
(43) Pub. Date: Jun. 19, 2008

(54) FRONT PILLAR FOR FRAMELESS DOOR IN AUTOMOBILE

(76) Inventor: Jae Hyuck Lee, Seongnam-city (KR)

Correspondence Address: MORGAN, LEWIS & BOCKIUS LLP (SF), One Market, Spear Street Tower, Suite 2800, San Francisco, CA, 94105, US

(21) Appl. No.: 11/943,348

(22) Filed: Nov. 20, 2007

(30) Foreign Application Priority Data
Dec. 14, 2006 (KR) 10-2006-0127813

(51) Int. Cl. B60R 27/00

(52) U.S. Cl. 296/202

(57) ABSTRACT

A front pillar for a frameless automobile door includes an outer and an inner panel, attached at their upper ends; and a bracket disposed between the lower ends of the panels, configured for a door glass to be inserted therein. The lower end of the outer panel is directly connected to the bracket. A weather strip may be provided on the bracket, and may include a first portion, with a first end disposed in the bracket and a second end supported by the outer panel; and a second portion, which is connected to a junction between the bracket and the inner panel. The bracket may include a first panel, connected to the inner panel; a second panel, connected to the outer panel; and a third panel, which extends between the first and second panels. The lower end of the outer panel may curve around the end of the bracket.

### CROSS-REFERENCE TO RELATED APPLICATION

This application claims priority to, and the benefit of, Korean Patent Application No. 10-2006-0127813, filed in the Korean Intellectual Property Office on Dec. 14, 2006, the entire contents of which are incorporated herein by reference.

### BACKGROUND OF THE INVENTION

(a) Field of the Invention

The present invention relates to a front pillar for a frameless door in an automobile.

(b) Description of the Related Art

Generally, some vehicles, such as convertibles, include frameless doors, i.e. doors without upper window frames. In vehicles with such doors, the window is sealed by weather strips provided on the roof and front pillar.

A molding is provided on the front pillar, a bracket is disposed thereon, and the weather strip is disposed on the bracket. The molding is exposed, which is not aesthetically pleasing. Further, the structure must be waterproofed and soundproofed.

The above information disclosed in this Background section is only for enhancement of understanding of the background of the invention and therefore it may contain information that does not form the prior art that is already known in this country to a person of ordinary skill in the art.

### SUMMARY OF THE INVENTION

A front pillar for a frameless door in an automobile includes an outer and an inner panel, attached at their upper ends; and a bracket disposed between the lower ends of the panels, configured for a door glass to be inserted therein. The lower end of the outer panel is directly connected to the bracket.

A weather strip may be provided on the bracket, and may include a first portion, of which a first end is disposed in the bracket and a second end is supported by the outer panel; and a second portion, which is connected to a junction between the bracket and the inner panel.

The bracket may include a first panel, connected to the inner panel; a second panel, connected to the outer panel; and a third panel, which extends between the first and second panels.

The lower end of the outer panel may curve around the end of the bracket.

### BRIEF DESCRIPTION OF THE DRAWINGS

FIG. 1 is a schematic view of a vehicle body.

FIG. 2 is a cross-sectional view taken along line A-A of FIG. 1, showing a front pillar for a frameless door according to an exemplary embodiment of the present invention.

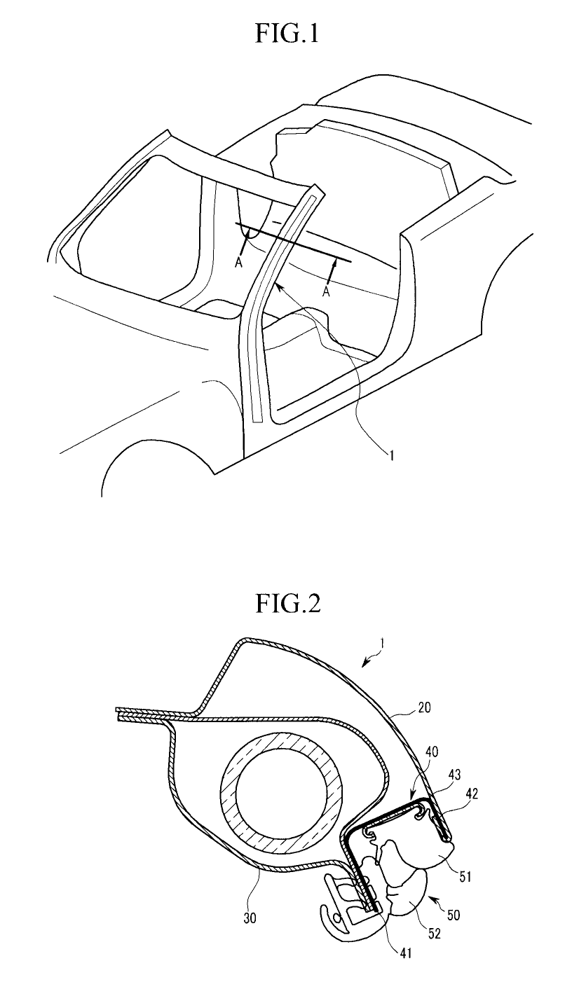

### DETAILED DESCRIPTION OF PREFERRED EMBODIMENTS

The present invention will now be described more fully hereinafter with reference to the accompanying drawings.

Referring to FIG. 2, a front pillar 1 for a frameless door in an automobile according to an exemplary embodiment of the present invention includes an outer panel 20 and an inner panel 30. The front pillar 1 also includes a bracket 40, disposed between the outer panel 20 and the inner panel 30, in which a door glass (not shown) is inserted when the door glass is closed. The outer panel 20 extends to the end of the bracket 40. A separate molding is not necessary, and the placement of the bracket 40 between the outer panel 20 and the inner panel 30 improves waterproofing and sound insulation characteristics, and simplifies manufacturing and assembly processes.

A weather strip 50 is provided in the bracket 40, and the weather strip 50 closely contacts the door glass when the door glass is closed.

Preferably, the weather strip 50 includes a first weather strip portion 51 and a second weather strip portion 52. One end of the first weather strip portion 51 is inserted into the bracket 40, and the other end of the first weather strip portion 51 is supported by the outer panel 20. The second weather strip portion 52 is connected to the junction between the bracket 40 and the inner panel 30. This weather strip structure further improves waterproofing and sound insulation characteristics.

The bracket 40 includes a first flat panel 41, which is connected with the inner panel 30; a second flat panel 42, which is connected with outer panel 20; and a third flat panel 43, which connects the first flat panel 41 and the second flat panel 42. The bracket 40 is generally U-shaped, improving sealing characteristics.

The rightmost end in FIG. 2 of the outer panel 20 curves around the second flat panel 42, and the panel 42 and the bent portion of the outer panel 20 are joined with a hemming process.

The front pillar for a frameless door in an automobile according to an exemplary embodiment of the present invention has the advantage of not including a molding, improving the aesthetic appearance. Further, the bracket improves waterproofing and sound insulation characteristics, and simplifies manufacturing and assembly processes.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A front pillar for a frameless door in an automobile, comprising:
an outer panel;
an inner panel, wherein the outer and inner panels are attached at upper ends thereof; and
a bracket disposed between lower ends of the outer panel and the inner panel, configured for a door glass to be inserted therein;
wherein the lower end of the outer panel is directly connected to the bracket.

2. The front pillar of claim 1, further comprising a weather strip on the bracket, configured to contact the door glass.

3. The front pillar of claim 2, wherein the weather strip comprises:
a first weather strip portion, of which a first end is disposed in the bracket and a second end is supported by the outer panel; and
a second weather strip portion, which is connected to a junction between the bracket and the inner panel.

4. The front pillar of claim 1, wherein the bracket comprises:
a first panel, connected to the inner panel;
a second panel, connected to the outer panel; and
a third panel, which extends between the first and second panels.

5. The front pillar of claim 1, wherein the lower end of the outer panel curves around an end of the bracket.
